(19) United States
(12) Patent Application Publication
(10) Pub. No.: US 2003/0140076 A1
(43) Pub. Date: Jul. 24, 2003

(54) Interleaved arithmetic logic units

(75) Inventors: David Arnold Luick, Rochester, MN (US); Michael James Rohn, Rochester, MN (US)

Correspondence Address: Gero G. McClellan, Moser, Patterson & Sheridan, L.L.P., 3040 Post Oak Boulevard, Suite 1500, Houston, TX, 77056-6582, US

(73) Assignee: International Business Machines Corporation, Armonk, NY (US)

(21) Appl. No.: 10/054,393

(22) Filed: Jan. 22, 2002

(51) Int. Cl. G06F 7/38

(52) U.S. Cl. 708/490

(57) ABSTRACT

Embodiments are provided in which two or more sub-ALUs are interleaved to form a single ALU so as to shorten and reduce the number of the connection lines interconnecting the ALU to other devices.

### BACKGROUND OF THE INVENTION

1. Field of the Invention

The present invention generally relates to arithmetic logic units (ALUs), and more particularly to an ALU that has a simpler wiring scheme than that of prior art.

2. Description of the Related Art

In a conventional processor that has multiple ALUs, it is required that each ALU have its inputs connected to data sources such as a register file, a data cache, the ALU's own outputs, and the outputs of other ALUs of the processor. It is also required that each ALU have its result outputs connected to data destinations such as the register file, the data cache, the ALU's own inputs, and the inputs of other ALUs of the processor.

More specifically, assuming a processor has two ALUs, there must be physical connection lines connecting the data cache to the inputs of both ALUs, connecting the register file to the inputs of both ALUs, connecting the result outputs of both ALUs to the data cache, connecting the result outputs of both ALUs to the register file, and connecting the result outputs of each ALU to its own inputs and the inputs of the other ALU. These physical connection lines occupy a substantial area (real estate) of the processor die. When the number of ALUs in the processor increases, the number of connection lines required increases substantially. Increasing the number of physical connection lines increases the area occupied by the physical lines and the power dissipation. Moreover, increasing the number of physical lines calls for thicker and wider metal levels as well as increased isolation and possible inductive control overhead in order to maintain high performance. Increasing the number of physical connection lines also lengthens the connection lines. As a result, each individual bus requires its own bus drivers, leading to more power dissipation.

In addition to requiring more real estate, increasing the number of ALUs also increases the maximum length of the connection lines, leading to critical timing path problems. The critical timing path to a destination is defined as a path any additional delay along which would delay the processing at the destination. To avoid critical timing path problems, an effective process or design must avoid adding further delay to the critical timing path. In other words, the maximum length of the connection lines must not be increased when the number of ALUs in the processor increases.

To solve the critical timing path problems, prior art adds latch boundaries between units and uses an additional timing cycle to transfer data between units. Doing this adds another cycle of latency which slows down the overall processing speed, burns more power, adds to the wiring congestion to connect the units by requiring additional local wiring for the latches as well as global connection to those latches from the global clock distribution.

Accordingly, there is a need for an apparatus and method for implementing multiple ALUs in a system which requires relatively less area for the respective physical connection lines, shortens the longest connection lines and hence reduces the critical timing path, and reduces the number of connection lines interconnecting the ALUs and other units in the system.

### SUMMARY OF THE INVENTION

In one embodiment, an ALU comprises at least first and second sub-ALUs. Each of the first and second sub-ALUs includes a plurality of slices wherein the slices of the first and second sub-ALUs are interleaved.

In another embodiment, a method is used for implementing at least first and second sub-ALUs to form an ALU. Each of the first and second sub-ALUs includes a plurality of slices. The method comprises interleaving the slices of the first and second sub-ALUs.

In still another embodiment, a method is used for implementing at least first and second ALUs. The first ALU has a first input side and a first output side, the second ALU has a second input side and a second output side. The method comprises arranging the first and second ALUs using one of first and second arrangements. The first arrangement comprises arranging the first output side closer to the second output side than to the second input side. The second arrangement comprises arranging the first input side closer to the second input side than to the second output side.

In still another embodiment, a digital circuit comprises at least first and second ALUs. The first ALU has a first input side and a first output side, the second ALU has a second input side and a second output side. The first and second ALUs are arranged in one of first and second arrangements. In the first arrangement, the first output side is closer to the second output side than to the second input side. In the second arrangement, the first input side is closer to the second input side than to the second output side.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a computer system 100 according to one embodiment.

FIG. 2a shows one embodiment of the ALU 200 of FIG. 1.

FIG. 2b shows one embodiment of the ALU 200 of FIG. 2a.

FIG. 2c shows how the inputs and outputs of the ALU 200 can be connected in one embodiment.

FIG. 2d shows a conventional ALU 200d for comparison with the ALU 200 of FIG. 2c.

FIG. 2e shows conventional ALU 0 and ALU 1 in connection with other units.

FIG. 2f shows a single ALU 0/1 according to one embodiment of the invention for comparison with the ALU 0 and ALU 1 of FIG. 2e.

FIG. 2g shows one embodiment of a cross-sectional view of the ALU 200.

FIG. 3 shows an ALU 300 according to one embodiment.

FIG. 4 shows an ALU 400 according to one embodiment.

FIG. 5 shows how two ALUs 200a & 200b can be arranged and connected according to one embodiment.

### DETAILED DESCRIPTION OF THE PREFERRED EMBODIMENTS

Embodiments are provided in which two or more sub-ALUs are interleaved to form a single ALU so as to shorten and reduce the number of the connection lines interconnecting the ALU to other devices.

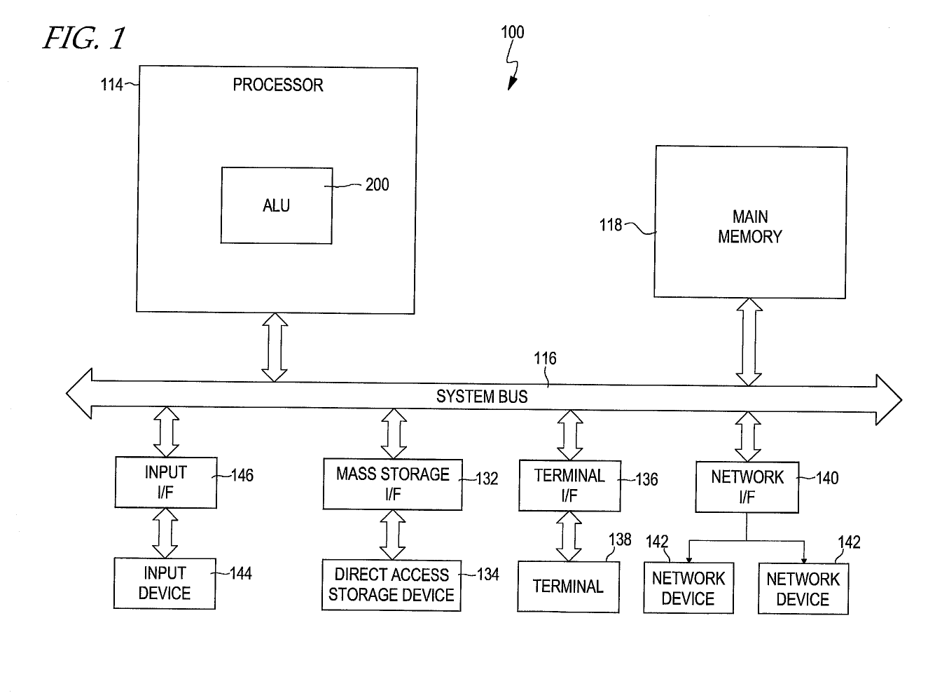

FIG. 1 shows a computer system 100 according to one embodiment. Illustratively, the computer system 100 includes a system bus 116, at least one processor 114 coupled to the system bus 116. The processor 114 includes an Arithmetic Logic Unit (ALU) 200. The computer system 100 also includes an input device 144 coupled to system bus 116 via an input interface 146, a storage device 134 coupled to system bus 116 via a mass storage interface 132, a terminal 138 coupled to system bus 116 via a terminal interface 136, and a plurality of networked devices 142 coupled to system bus 116 via a network interface 140.

Terminal 138 is any display device such as a cathode ray tube (CRT) or a plasma screen. Terminal 138 and networked devices 142 may be desktop or PC-based computers, workstations, network terminals, or other networked computer systems. Input device 144 can be any device to give input to the computer system 100. For example, a keyboard, keypad, light pen, touch screen, button, mouse, track ball, or speech recognition unit could be used. Further, although shown separately from the input device, the terminal 138 and input device 144 could be combined. For example, a display screen with an integrated touch screen, a display with an integrated keyboard or a speech recognition unit combined with a text speech converter could be used.

Storage device 134 is DASD (Direct Access Storage Device), although it could be any other storage such as floppy disc drives or optical storage. Although storage 134 is shown as a single unit, it could be any combination of fixed and/or removable storage devices, such as fixed disc drives, floppy disc drives, tape drives, removable memory cards, or optical storage. Main memory 118 and storage device 134 could be part of one virtual address space spanning multiple primary and secondary storage devices.

The contents of main memory 118 can be loaded from and stored to the storage device 134 as processor 114 has a need for it. Main memory 118 is any memory device sufficiently large to hold the necessary programming and data structures of the invention. The main memory 118 could be one or a combination of memory devices, including random access memory (RAM), non-volatile or backup memory such as programmable or flash memory or read-only memory (ROM). The main memory 118 may be physically located in another part of the computer system 100. While main memory 118 is shown as a single entity, it should be understood that memory 118 may in fact comprise a plurality of modules, and that main memory 118 may exist at multiple levels, from high speed registers and caches to lower speed but larger DRAM chips.

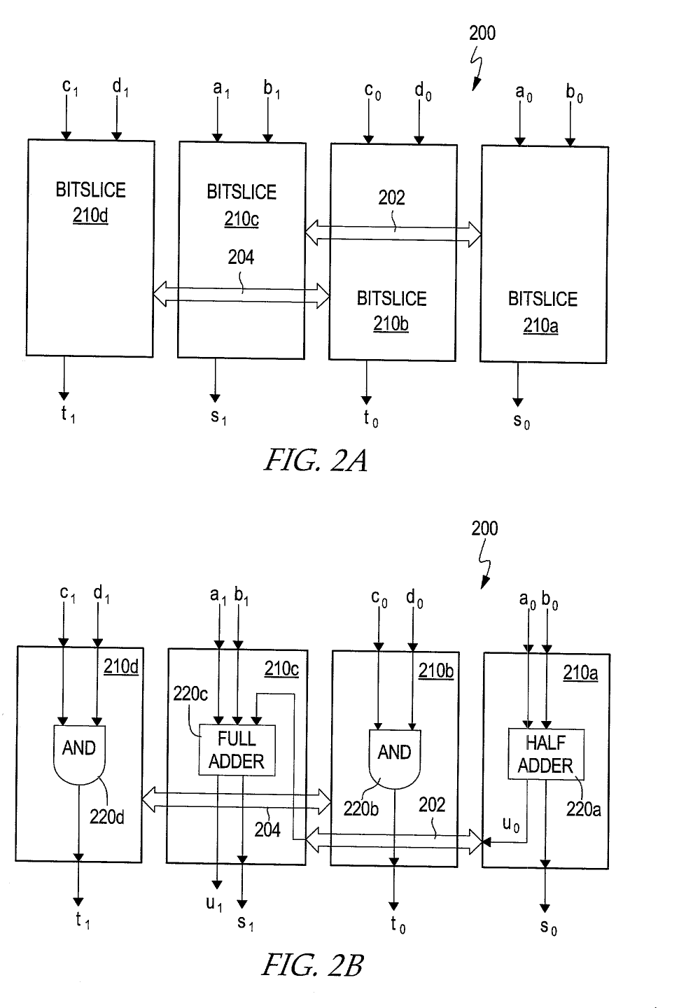

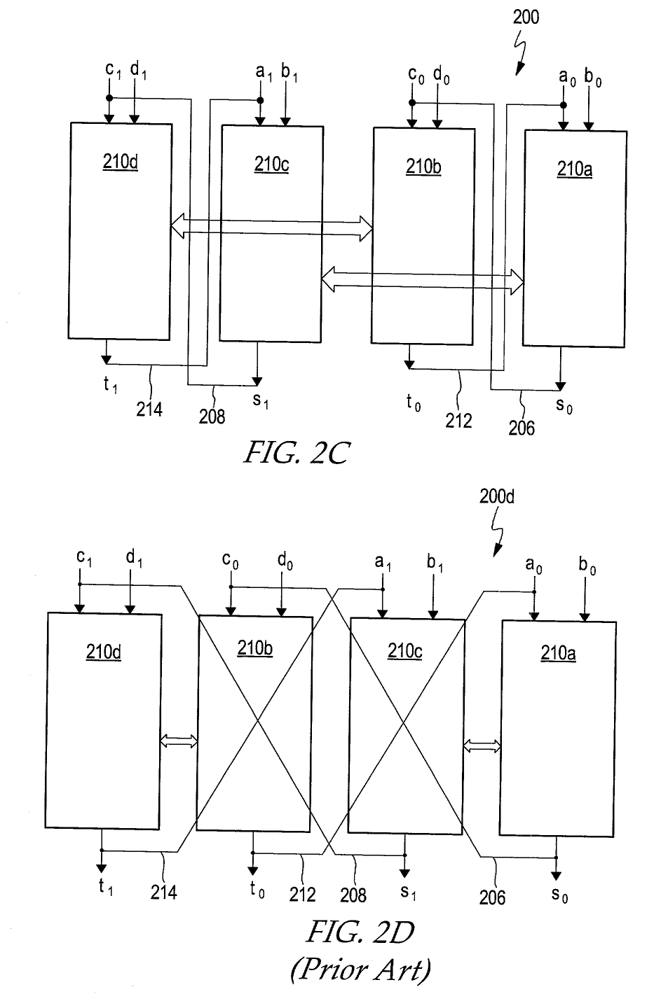

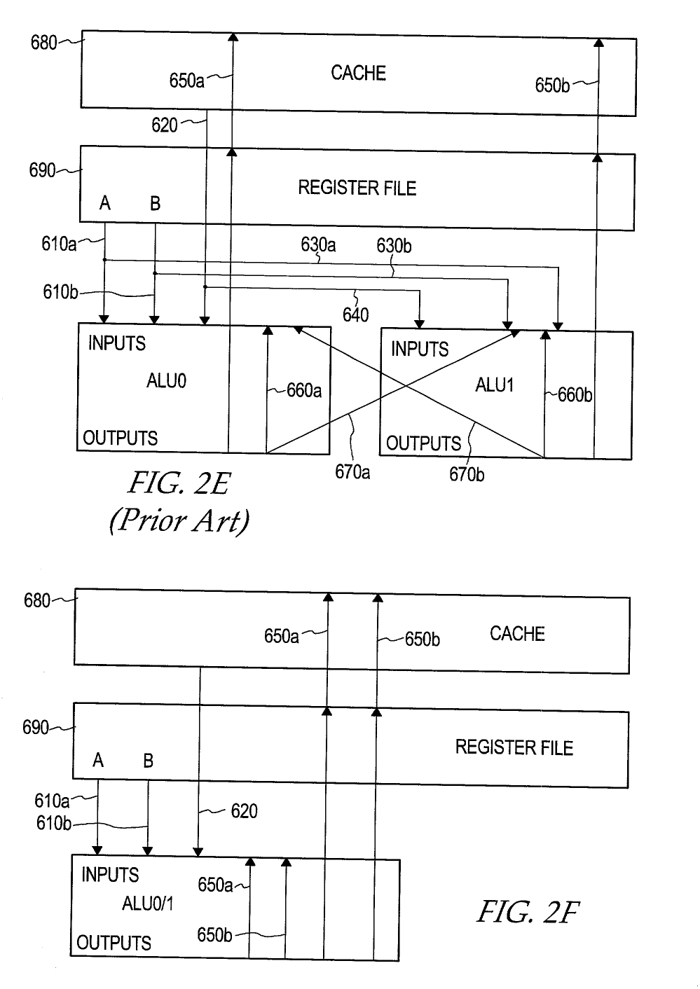

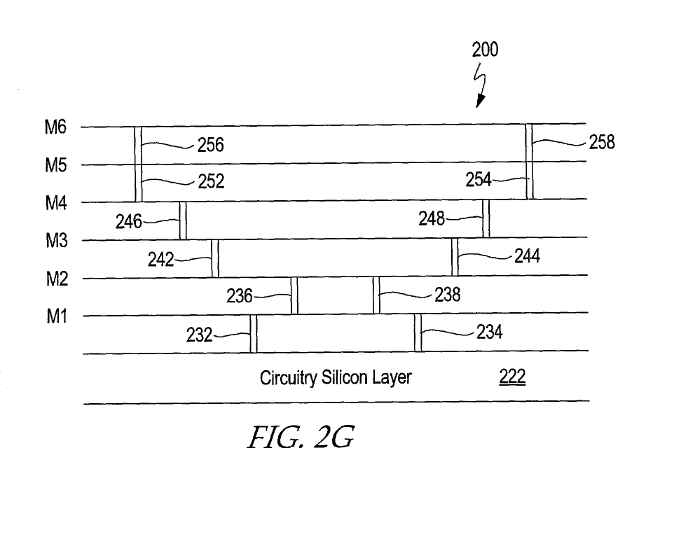

FIG. 2a shows one embodiment of the ALU 200 of FIG. 1. The same reference numeral in different figures indicates the same circuit. The ALU 200 includes, illustratively, Bitslices 210a, 210b, 210c, and 210d. Bitslices 210a and 210c communicate via connection 202 to form a first sub-ALU 210a,210c. Bitslices 210b and 210d communicate via connection 204 to form a second sub-ALU 210b,210d. The first sub-ALU 210a,210c and the second sub-ALU 210b,210d have their Bitslices interleaved. That is, if one bitslice in a row of bitslices belongs to the first sub-ALU 210a,210c, the two adjacent bitslices belong to the second sub-ALU 210b,210d. In other words, if one bitslice in the row of bitslices belongs to the second sub-ALU 210b,210d, the two adjacent bitslices belong to the first sub-ALU 210a,210c.

In one embodiment, with reference to the first sub-ALU 210a,210c, the Bitslice 210a receives two input bits a0 and b0 of two numbers A and B, respectively. Illustratively, number A has two bits a0 and a1, with a1 being the most significant bit and a0 being the least significant bit. Similarly, number B has two bits b0 and b1, with b1 being the most significant bit and b0 being the least significant bit. The Bitslice 210a generates an output bit s0. The Bitslice 210c receives two input bits a1 and b1 of the two numbers A and B, respectively, and generates an output bit s1.

With reference to the second sub-ALU 210b,210d, the Bitslice 210b receives two input bits c0 and d0 of two numbers C and D, respectively. Illustratively, number C has two bits c0 and c1, with c1 being the most significant bit and c0 being the least significant bit. Similarly, number D has two bits d0 and d1, with d1 being the most significant bit and d0 being the least significant bit. The Bitslice 210b generates an output bit t0. The Bitslice 210d receives two input bits c1 and d1 of the two numbers C and D, respectively, and generates an output bit t1.

FIG. 2b shows one embodiment of the ALU 200 of FIG. 2a. In this embodiment, the Bitslice 210a of the first sub-ALU 210a,210c includes a Half Adder 220a. The Half Adder 220a adds the two inputs a0 and b0, and generates a one-bit sum as output s0 and a one-bit carry u0. For example, if a0 and b0 are 1b (one binary) and 1b, respectively, then u0 and s0 should be 1b and 0b, respectively. The output u0 of the Half Adder 220a is applied to the Bitslice 210c via the connection 202.

The Bitslice 210c of the first sub-ALU 210a,210c includes a Full Adder 220c. The Full Adder 220c adds three inputs a1, b1, and the carry u0 from the Half Adder 220a. The Full Adder 220c generates a one-bit sum as output s1 and a one-bit carry u1. For example, if a1, b1, and the carry u0 are 1b, 1b, and 1b, respectively, then u1 and s1 will be 1b and 1b, respectively.

As a result, in this embodiment, the first sub-ALU 210a,210c can add two two-bit numbers A and B and generate a carry u1 and a two-bit sum S. The sum S has two bits s1 and s0, with s1 being the most significant bit and s0 being the least significant bit.

In another embodiment, the Bitslice 210b of the second sub-ALU 210b,210d includes an AND gate 220b. The AND gate 220b “ands” the two inputs c0 and d0, and generates a one-bit result as output t0. For example, if c0 and d0 are 1b (one binary) and 0b, respectively, then t0 should be 0b.

Similarly, the Bitslice 210d of the second sub-ALU 210b,210d also includes an AND gate 220d. The AND gate 220d “ands” the two inputs c1 and d1, and generates a one-bit result as output t1. For example, if c1 and d1 are 1b and 0b, respectively, then t1 should be 0b. As a result, the second sub-ALU 210b,210d can “and” two two-bit numbers C and D and generate a two-bit result T having two bits t1 and t0, with t1 being the most significant bit and t0 being the least significant bit.

In one embodiment, the Bitslices 210a and 210c of the first sub-ALU 210a,210c include other circuits so that the first sub-ALU 210a,210c can perform other arithmetic and logic operations on the numbers A and B. For instance, the first sub-ALU 210a,210c may further include a first AND gate in the Bitslice 210a and a second AND gate in the Bitslice 210c so that the first sub-ALU 210a,210c can perform AND operations on the numbers A and B. For purposes of simplicity, the first and second AND gates are not shown in the first sub-ALU 210a,210c of FIG. 2b. The first and second AND gates of the first sub-ALU 210a,210c may be connected in a similar manner to that of the two AND gates 220b and 220d of the second sub-ALU 210b,210, respectively. That is the first AND gate receives inputs a0 and b0 and generates a result output as output s0. Similarly, the second AND gate receives inputs a1 and b1 and generates a result output as output s1. Similarly, the Bitslices 210b and 210d of the second sub-ALU 210b,210d may include other circuits so that the second sub-ALU 210b,210d can perform other arithmetic and logic operations on the numbers C and D.

FIG. 2c shows how the inputs and outputs of the ALU 200 can be connected in one embodiment. The outputs s0 and s1 of the first sub-ALU 210a,210c are connected to the inputs c0 and c1 of the second sub-ALU 210b,210d via connection lines 206 and 208, respectively. As a result, the result outputs of the first sub-ALU 210a,210c are fed as inputs to the second sub-ALU 210b,210d. Because the Bitslices of the first sub-ALU 210a,210c and the second sub-ALU 210b,210d are interleaved, the connection lines 206 and 208 connect adjacent Bitslices. More specifically, the connection line 206 connects the output s0 of the Bitslice 210a to the input c0 of the adjacent Bitslice 210b. The connection line 208 connects the output s1 of the Bitslice 210c to the input c1 of the adjacent Bitslice 210d. As a result, the connection lines 206 and 208 are shorter than if the Bitslices of the first sub-ALU 2110a,210c and the second sub-ALU 210b,210d were not interleaved.

Similarly, the outputs t0 and t1 of the second sub-ALU 210b,210d are connected to the inputs a0 and a1 of the first sub-ALU 210a,210c via connection lines 212 and 214, respectively. As a result, the result outputs of the second sub-ALU 210b,210d are fed as inputs to the first sub-ALU 210a,210c. Because the Bitslices of the first sub-ALU 210a,210c and the second sub-ALU 210b,210d are interleaved, the connection lines 212 and 214 connect adjacent Bitslices. More specifically, the connection line 212 connects the output t0 of the Bitslice 210b to the input a0 of the adjacent Bitslice 210a. The connection line 214 connects the output t1 of the Bitslice 210d to the input a1 of the adjacent Bitslice 210c. As a result, the connection lines 212 and 214 are shorter than if the Bitslices of the first sub-ALU 210a,210c and the second sub-ALU 210b,210d were not interleaved.

For purposes of comparison with some embodiments of the invention, FIG. 2d shows a conventional ALU 200d. The ALU 200d is similar to the ALU 200 of FIG. 2c except that the sub-ALUs 210a,210c & 210b,210d of the ALU 200d in FIG. 2d do not have their bitslices interleaved. As a result, even if the sub-ALUs 210a,210c & 210b,210d of the ALU 200d are located next to each other, the physical connection lines 206, 208, 212, and 214 are longer in FIG. 2d than in FIG. 2c.

Moreover, if each of the bitslices 210a, 210b, 210c, and 210d is required to have its output connected to its own input, the ALU 200 of FIG. 2c will have fewer connection lines than the ALU 200d of FIG. 2d. For instance, with reference to FIG. 2c, a connection line connecting the output s0 to the inputs a0 or b0 is not needed. A short connection line connecting input c0 to input a0 or b0 is sufficient. This short connection line and the connection line 206 make a path from the output s0 of the bitslice 210a to the input a0 or b0 of the same bitslice 210a. The connection line connecting input c0 to input a0 or b0 is short because the two bitslices 210a and 210b are adjacent. With reference to FIG. 2d, the distance between the input c0 of the bitslice 210b and input a0 or b0 of the bitslice 210a is great, especially when there are many bitslices in each of the first and second sub-ALUs. As a result, for each bitslice of the ALU 200d, a separate connection line is needed to connect its own output and input. For instance, a separate connection line is needed to connect the output s0 of the bitslice 210a to the input a0 or b0 of the same bitslice 210a.

With reference back to FIG. 2c, if a number is to be used as input for both the first sub-ALU 210a, 210c and the second sub-ALU 210b,210d, there is no need for a long connection line connecting the inputs of the first sub-ALU 210a,210c and the second sub-ALU 210b,210d. For instance, assume a two-bit number X is to be used as input for both the first sub-ALU 210a,210c and the second sub-ALU 210b,210d. A least significant bit x0 of X can be connected to both inputs a0 and c0 of the first sub-ALU 210a,210c and the second sub-ALU 210b,210d, respectively. Similarly, a next bit x1 of X can be connected to both inputs a1 and c1 of the first sub-ALU 210a,210c and the second sub-ALU 210b,210d, respectively. Because the inputs a0 and c0 belong to adjacent Bitslices 210a and 210b, respectively, the connection line connecting the inputs a0 and c0 is shorter than if the Bitslices of the first sub-ALU 210a,210c and the second sub-ALU 210b,210d were not interleaved. Similarly, because the inputs a1 and c1 belong to adjacent Bitslices 210c and 210d, respectively, the connection line connecting the inputs a1 and c1 is shorter than if the Bitslices of the first sub-ALU 210a,210c and the second sub-ALU 210b,210d were not interleaved.

For purposes of comparison with some embodiments of the invention, FIG. 2e shows conventional ALU 0 and ALU 1 not having their bitslices interleaved and in connection with a cache 680 and a register file 690. There are 12 physical connection lines 610a, 610b, 620, 630a, 630b, 640, 650a, 650b, 660a, 660b, 670a, and 670b, each representing an independent bus, connecting the ALU 0, ALU 1, the cache 680, and the register file 690. The buses 610a and 610b connect register A and register B of the register file 690 to the inputs of the ALU 0, respectively. The buses 630a and 630b connect register A and register B of the register file 690 to the inputs of the ALU 1, respectively. The buses 620 & 640 connects the cache to the inputs of the ALU 0 and the ALU 1, respectively. The bus 650a connects the outputs of ALU 0 to the register file 690 and the cache 680. The bus 650b connect the outputs of ALU 1 to the register file 690 and the cache 680. The bus 660a connects the outputs of ALU 0 to the inputs of ALU0. The bus 660b connects the outputs of ALU 1 to the inputs of ALU1. The bus 670a connects the outputs of ALU 0 to the inputs of ALU 1. Finnaly, the bus 670b connects the outputs of ALU 1 to the inputs of ALU 0.

For purposes of comparison, FIG. 2f shows a single ALU 0/1 according to one embodiment of the invention. The ALU 0/1 has the same bitslices as the ALU 0 and ALU 1, except that the bitslices of the ALU 0/1 are interleaved. As a result of interleaving the bitslices of the ALU 0/1, the buses 630a, 630b, 640, 670a, and 670b, which are present in non-interleaved ALU 0 and ALU 1, may be omitted in the interleaved ALU 0/1 of FIG. 2f. As a result, the total number of buses has been reduced from 12 (in the case of the configuration shown in FIG. 2e) to 7.

FIG. 2g shows one embodiment of a cross-sectional view of the ALU 200. The ALU 200 of FIG. 2g is intended to illustrate a possible fabrication scheme. However, it is understood that the ALU 200 shown in FIG. 2g is merely illustrative and embodiments of the invention are not limited by a particular fabrication scheme nor a particular method of fabrication. The ALU 200 includes, illustratively, a circuitry silicon layer 222 and six metal interconnect layers M1, M2, M3, M4, M5, and M6. Sandwiched between two adjacent metal interconnect layers is an inter-metal dielectric layer. The circuitry silicon layer 222 contains the circuits of the ALU 200. For instance, the AND gates 220b and 220d of FIG. 2b reside in the circuitry silicon layer 222.

The metal interconnect layer M1 is connected to the circuitry silicon layer 222 via contact holes 232 and 234. More or less than two contact holes may be needed depending on the complexity of the circuitry in the circuitry silicon layer 222. The contact holes 232 and 234 are filled with conducting materials. A metal interconnect layer is connected to its adjacent metal interconnect layer(s) through two vias. More or less than two vias may be needed depending on the complexity of the circuitry in the circuitry silicon layer 222. More specifically, the metal interconnect layers M1 and M2 are connected through vias 236 and 238. The metal interconnect layers M2 and M3 are connected through vias 242 and 244. The metal interconnect layers M3 and M4 are connected through vias 246 and 248. The metal interconnect layers M4 and M5 are connected through vias 252 and 254. The metal interconnect layers M5 and M6 are connected through vias 256 and 258. The vias 236, 238, 242, 244, 246, 248, 252, 254, 256, and 258 are filled with conducting materials. The vias 236, 238, 242, 244, 246, 248, 252, 254, 256, and 258 and the metal interconnect layers M1, M2, M3, M4, M5, and M6 connect various components of the circuitry of the ALU 200 and connect the ALU 200 to other devices. For instance, the vias 252 and 254 can be used as outputs s0 and s1 of FIG. 2a, respectively.

Technically, the ALU 200 does not include the metal interconnect layer M6. Rather, the metal interconnect layer M6 contains global connection wires connecting the ALU 200 with other devices and connecting the inputs and outputs of the ALU 200. For instance, the connection wires 206, 208, 212, 214 of FIG. 2c reside in the metal interconnect layer M6. As a result, these wires 206, 208, 212, 214 of FIG. 2c can run above the ALU 200.

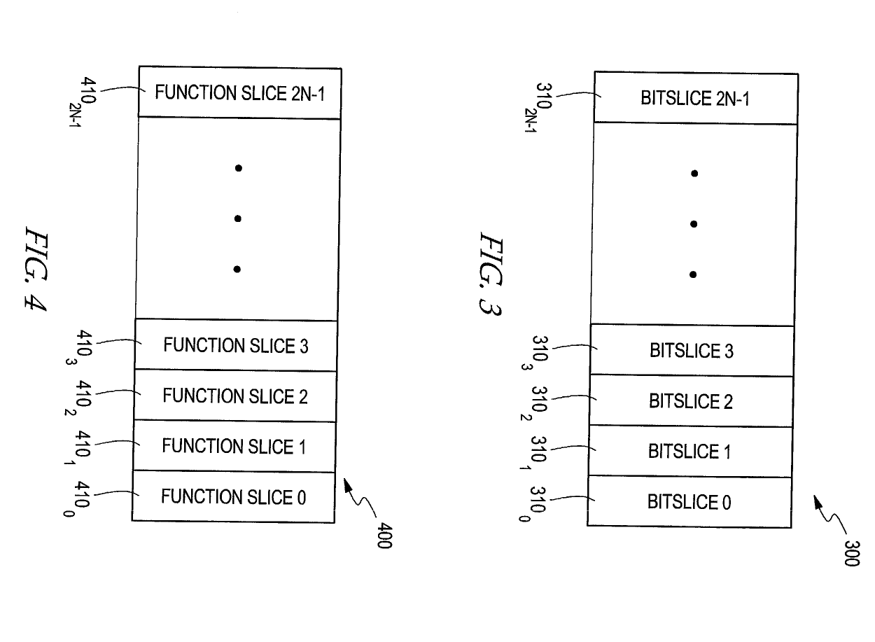

For simplicity, the ALU 200 as shown in FIGS. 2a, 2b, 2c has only four Bitslices 210a, 210b, 210c, and 210d. However, an ALU of the invention may have any number of bitslices. In one embodiment, shown in FIG. 3, the ALU 300 has 2N Bitslices 310i (i=0 to 2N−1) but may otherwise be similar to the ALU 200. More specifically, the N Bitslices 310i (i=even) connect in series to form a third sub-ALU. That is, the Bitslice 310₀ connects to the Bitslice 310₂, which in turn connects to the Bitslice 310₄, and so on. The N Bitslices 310i (i=odd) connect in series to form a fourth sub-ALU. That is the Bitslice 310i connects to the Bitslice 310₃, which in turn connects to the Bitslice 310₅, and so on. The third and fourth sub-ALUs have their Bitslices 310i (i=0 to 2N−1) interleaved. Illustratively, the third sub-ALU can perform arithmetic and logic operations on two N-bit numbers F and G and the fourth sub-ALU can perform arithmetic and logic operations on two N-bit numbers H and 1. The third sub-ALU has its outputs connected to its own inputs and to the inputs of the fourth sub-ALU. The fourth sub-ALU has its outputs connected to its own inputs and to the inputs of the third sub-ALU. Because the Bitslices 310i (i=0 to 2N−1) of the third and fourth sub-ALUs are interleaved, the connection lines connecting the outputs of one of the third and fourth sub-ALUs with the inputs of the other sub-ALU are shorter than if the Bitslices 310i (i=0 to 2N−1) of the third and fourth sub-ALUs are not interleaved.

In another embodiment, ALUs are function slice interleaved. FIG. 4 shows a top view of one embodiment of a function slice interleaved ALU 400. The ALU 400 includes 2N Function Slices 410i (i=0 to 2N−1). The N Function Slices 410i (i=even) connect in series to form a fifth sub-ALU. That is, the Function Slice 410₀ connects to the Function Slice 410₂ which in turn connects to the Function Slice 410₄, and so on. The N Function Slices 410i (i=odd) connect in series to form a sixth sub-ALU. That is, the Function Slice 410₁ connects to the Function Slice 410₃ which in turn connects to the Function Slice 410₅, and so on. The fifth and sixth sub-ALUs have their Function Slices 410i (i=0 to 2N−1) interleaved.

The ALU 400 and the ALU 300 utilize the same inventive interleaving concept. In the ALU 300, the arithmetic and logic operations on the numbers are split into bit operations. The result of bit operations are combined to yield a final result. In the ALU 400, the arithmetic and logic operations on numbers are split into functions such as addition, AND, OR, Shift, etc. Each of these functions operates, in turn, on the numbers to yield the final result. The fifth and sixth sub-ALUs operate in parallel. Because, the Function Slices 410i (i=0 to 2N−1) of the fifth and sixth sub-ALUs are interleaved, the connection lines connecting the outputs of one of the fifth and sixth sub-ALU with the inputs of the other sub-ALU are shorter than if the Function Slices 410i (i=0 to 2N−1) of the fifth and sixth sub-ALUs are not interleaved. For example, the Function Slices 410₀ & 410₁ are adjacent. The connection wire connecting the output of the Function Slices 410₀ to the input of the Function Slices 410₁ is short. The connection wire would be longer if the Function Slices 410₀ & 410₁ were not adjacent.

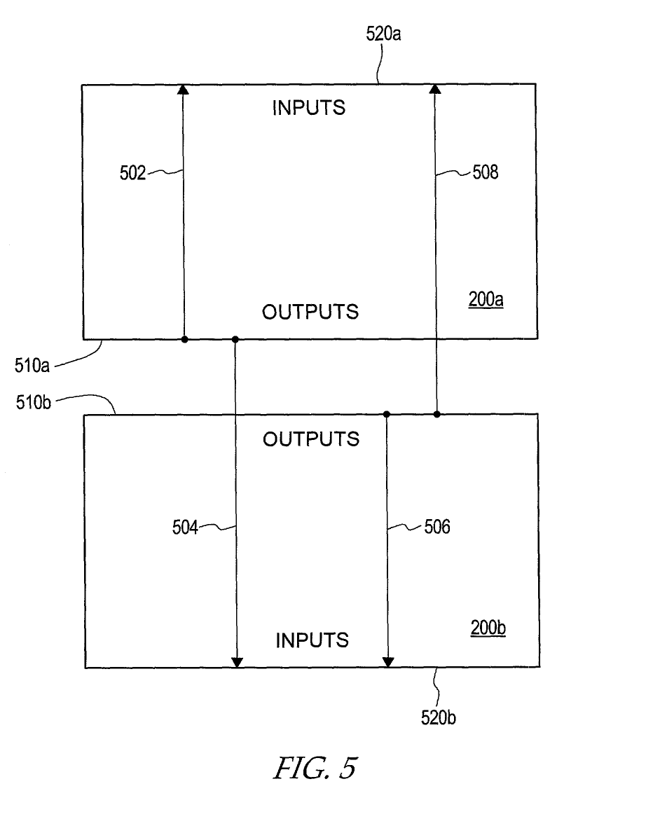

FIG. 5 shows how two ALUs 200a & 200b can be arranged and connected in one embodiment. Each of the ALUs 200a & 200b may be similar to the ALUs 200, 300, or 400. The output sides 510a & 510b of the ALUs 200a & 200b, respectively, are arranged proximate to each other. The input sides 520a & 520b of the ALUs 200a & 200b, respectively, are arranged relatively distant from each other. Alternatively, in another embodiment, the output sides 510a & 510b of the ALUs 200a & 200b, respectively, may be arranged relatively distant from each other. The input sides 520a & 520b of the ALUs 200a & 200b, respectively, may be arranged proximate together. Each ALU of the two ALUs 200a & 200b has its outputs connected to its own inputs and to the inputs of the other ALU via connection wires 502, 504, 506, and 508. Because the ALUs 200a & 200b have their bitslices interleaved, the wiring is much less complicated than if their bitslices are not interleaved. As a result, the connection lines are shorter than in prior art, leading to less power dissipation and less required real estate. Shorter connection lines also reduces the overall wiring requirements and does not create critical timing path problems. In addition, shorter connection lines does not require thicker and wider metal levels as well as increased isolation and possible inductive control overhead in order to maintain high performance. Moreover, shorter connection lines means a reduction in the total number of output drivers since the number of buses is reduced.

While the foregoing is directed to embodiments of the present invention, other and further embodiments of the invention may be devised without departing from the basic scope thereof, and the scope thereof is determined by the claims that follow.

What is claimed is:

1. An Arithmetic and Logic Unit (ALU), comprising:
at least first and second sub-ALUs, each of the first and second sub-ALUs including a plurality of slices wherein the slices of the first and second sub-ALUs are interleaved.

2. The ALU of claim 1 wherein the slices of the first and second sub-ALUs are bitslices.

3. The ALU of claim 2 wherein each of the bitslices of the first sub-ALU includes a gate configured to perform a logical operation.

4. The ALU of claim 3 wherein the gate is configured to receive two input bits and generate one output bit.

5. The ALU of claim 3 wherein the logical operation is logical AND operation.

6. The ALU of claim 2 wherein the bitslices of the first sub-ALU are connected in series.

7. The ALU of claim 6 wherein the bitslices of the second sub-ALU are connected in series.

8. The ALU of claim 6 wherein each of the bitslices of the first sub-ALU includes an adder configured to add at least two bits to generate a carry bit to a next consecutive bitslice of the first sub-ALU.

9. The ALU of claim 2, wherein each pair of adjacent bitslices of the ALU comprises a first bitslice of the first sub-ALU and a second bitslice of the second sub-ALU; and wherein:
the first bitslice has a first input and a first output, a second bitslice has a second input and a second output; and
the first output is connected to the second input, and the second output is connected to the first input.

10. The ALU of claim 1 wherein the slices of the first and second sub-ALUs are function slices.

11. The ALU of claim 10 wherein the function slices of the first sub-ALU are connected in series and the function slices of the second sub-ALU are connected in series.

12. A method for implementing at least first and second sub-ALUs to form an ALU, each of the first and second sub-ALUs including a plurality of slices, the method comprising:
interleaving the slices of the first and second sub-ALUs.

13. The method of claim 12 wherein the slices of the first and second sub-ALUs are bitslices.

14. The method of claim 13 further comprising connecting the bitslices of the first sub-ALU in series.

15. The method of claim 14 further comprising connecting the bitslices of the second sub-ALU in series.

16. The method of claim 13, wherein each pair of adjacent bitslices of the ALU comprises a first bitslice of the first sub-ALU and a second bitslice of the second sub-ALU, and further comprising:
providing a first input and a first output for the first bitslice;
providing a second input and a second output for the second bitslice;
connecting the first output to the second input; and
connecting the second output to the first input.

17. The method of claim 12 wherein the slices of the first and second sub-ALUs are function slices.

18. The method of claim 17 further comprising connecting the function slices of the first sub-ALU in series and connecting the function slices of the second sub-ALU in series.

19. A method for implementing at least first and second ALUs, the first ALU having a first input side and a first output side, the second ALU having a second input side and a second output side, the method comprising:
arranging the first and second ALUs using one of first and second arrangements, wherein the first arrangement comprises arranging the first output side closer to the second output side than to the second input side, the second arrangement comprises arranging the first input side closer to the second input side than to the second output side.

20. The method of claim 19 wherein arranging the first and second ALUs comprises using the first arrangement.

21. The method of claim 19 further comprising:
connecting a first output of the first ALU to a first input of the second ALU; and
connecting a second output of the second ALU to a second input of the first ALU.

22. The method of claim 19 wherein each of the first and second ALUs has at least first and second sub-ALUs, each of the first and second sub-ALUs including a plurality of slices wherein the slices of the first and second sub-ALUs are interleaved.

23. A digital circuit, comprising at least first and second ALUs, the first ALU having a first input side and a first output side, the second ALU having a second input side and a second output side, wherein the first and second ALUs are arranged in one of first and second arrangements, wherein
in the first arrangement, the first output side is closer to the second output side than to the second input side, and
in the second arrangement, the first input side is closer to the second input side than to the second output side.

24. The digital circuit of claim 23 wherein a first output of the first ALU is connected to a first input of the second ALU and a second output of the second ALU is connected to a second input of the first ALU.

25. The digital circuit of claim 23 wherein each of the first and second ALUs has at least first and second sub-ALUs, each of the first and second sub-ALUs including a plurality of slices wherein the slices of the first and second sub-ALUs are interleaved.

26. The digital circuit of claim 23 wherein the slices of the first and second sub-ALUs comprises one of bitslices and function slices.
